(19) United States
(12) Patent Application Publication
(10) Pub. No.: US 2008/0254197 A1
(43) Pub. Date: Oct. 16, 2008

(54) Cabarb deluxe peanutchips

(76) Inventors: Carl L. Rogers, Missouri City, TX (US); Barbara Triplett, Missouri City, TX (US)

Correspondence Address: Mr. Carl L. Rogers, 7019 Dickson Way, Missouri City, TX, 77489, US

(21) Appl. No.: 11/517,609

(22) Filed: Apr. 10, 2007

(51) Int. Cl. A23L 1/36

(52) U.S. Cl. 426/632

(57) ABSTRACT

This abstract of the technical aspects of the Cabarb Deluxe Peanutchip represents the Quality, Nutritional, and convenience of the savvy way we're presenting a healthy and delicious snack that can and will be enjoyed by people of all ages. The Cabarb Deluxe Peanutchip will possess a natural, energy packed and delicious snack chip to be introduced to the market place today. These snack chips will allow families to take them on trips for healthy snacking, without the mess of shells, they can be taken to the work place for a tasty snack when you're too busy to take a luncheon break, children can take them to school to satisfy those midday snack attacks, & they can be taken to the gym to fulfill the protein and energy needs before and after a good workout. the Cabarb Deluxe Peanutchips are high in vitamin E,low in Saturated fat and contain No Cholesterol.

Cabarb Deluxe Peanutchips calls for the use of Nuts, Corn Starch,yeast,egg whites, Salt, Brown Sugar and peanut oil as the main/major ingredients.

The Cabarb Deluxe Peanuts, will contain ingredients that make them nutritionally valuable and a healthy snack. Specifically, Spanish dry roasted peanuts and Almonds will be used along with other flavors including but not limited to pecans, cashews, and macadamian nuts for the purpose of providing flavorful snacks for the public.

The NUTRITIONAL FACTS label will stress that these chips are low in fat and low in cholesterol along with their nutritional value. These nuts are a good source of fibre,vitamin E, magnesium,zinc, selenium, copper, potassium, phosphorous, biotin, niacin and iron.

Many of these nuts are also a great source of folic acid. Phytochemicals that are found in these nuts include ellagic acid, flavonoids, phenolic compounds that have been proven to improve and be beneficial to one's health. Some of these nuts shall include as much as eight forms of sterols, that are thought to help moderate cholesterol levels.

Most of these nuts are very low in saturated fats and none contain cholesterol because nuts are a plant product and cholesterol is found only in animal products. These nuts have been shown to improve cardiovascular health and will likely provide a healthy, energy packed wholesome and delicious snack that the public will enjoy.

I) Inventor(s) claim that they are introducing an innovative NEW Snack Chip made from Peanuts,Pecans, Walnuts,Cashews and Macadamian nuts. Nuts are a good source of fiber,vitaminE magnesium, zinc, selenium and other nutritional and healthy minerals. There is also NO cholesterol in nuts and have been shown to improve cardiovascular health.

II) Inventor(s) also claim that these Nut Chips are not only tasty but are also very healthy for you. They are low in saturated fat and are cholesterol-free and recent research has shown that eating an ounce of nuts a day in place of foods that are higher in saturated fat can lower cholesterol. Nuts such as almonds, walnuts and cashews, provide an all important protein that helps your exhausted muscles recover after a strenous workout. Plus they just really taste good.
